(19) United States
(12) Patent Application Publication
(10) Pub. No.: US 2023/0216368 A1
(43) Pub. Date: Jul. 6, 2023

(54) DRIVE UNIT

(71) Applicants: SHINANO KENSHI CO., LTD., Ueda-shi (JP); SENKO MEDICAL INSTRUMENT MFG. CO., LTD., Tokyo (JP)

(72) Inventors: Koshiro TANAKA, Nagano (JP); Taku MARUYA, Tokyo (JP); Kohkoh SHIMIZU, Tokyo (JP)

(73) Assignees: SHINANO KENSHI CO., LTD., Ueda-shi (JP); SENKO MEDICAL INSTRUMENT MFG. CO., LTD., Tokyo (JP)

(21) Appl. No.: 17/979,325

(22) Filed: Nov. 2, 2022

(30) Foreign Application Priority Data
Dec. 13, 2021 (JP) 2021-201799
Sep. 27, 2022 (JP) 2022-153537

(51) Int. Cl. H02K 5/22; H02K 7/14; H02K 7/00

(52) U.S. Cl. CPC H02K 5/22; H02K 7/14; H02K 7/003

(57) ABSTRACT

A drive unit includes a motor device including a motor main body, a case portion accommodating the motor main body, a pump driven by the motor main body being attachable to the case portion, and a cap portion provided on the case portion, and an operation jig attachable to and detachable from the cap portion.

### CROSS-REFERENCE TO RELATED APPLICATION

This application is based upon and claims the benefit of priority of the prior Japanese Patent Application No. 2021-201799, filed on Dec. 13, 2021, and the prior Japanese Patent Application No. 2022-153537, filed on Sep. 27, 2022, the entire contents of which are incorporated herein by reference.

### BACKGROUND

### (i) Technical Field

The present disclosure relates to a drive unit.

### (ii) Related Art

It is known that when a motor device attached to a pump fails or a power failure occurs, the pump is detached from the motor device and the pump is manually operated (See, for example, Japanese Unexamined Patent Application No. 03-28677).

### SUMMARY

According to an aspect of the present disclosure, there is provide a drive unit including: a motor device including: a motor main body; a case portion accommodating the motor main body, a pump driven by the motor main body being attachable to the case portion; and a cap portion provided on the case portion; and an operation jig attachable to and detachable from the cap portion, wherein the case portion is formed with an exposure opening through which a proximal end of a rotation shaft of the motor main body is exposed, and the cap portion includes an attachment and detachment opening through which the exposure opening is exposed, and the operation jig includes: a holder portion formed into a cylindrical shape; an operating shaft rotatably held in the holder portion; and a movable member that rotates in conjunction with the operating shaft and is held by the operating shaft so as to be movable forward and backward from a distal end of the operating shaft in a direction of an axis of the operating shaft; a first biasing member biases the movable member away from the operating shaft in a direction of the axis, the proximal end of the rotation shaft and the movable member formed into complementary shapes to be positioned at an unfitting position where the rotation shaft and the operating shaft are not fitted to each other or a fitting position where the rotation shaft and the operating shaft are fitted to each other in accordance with relative rotation of the rotation shaft and the operating shaft around the axis in a state where the operation jig is attached to the attachment and detachment opening, at the unfitting position, the movable member is pressed against the proximal end of the rotation shaft against a biasing force of the first biasing member, and at the fitting position, the movable member is biased by the first biasing member to be fitted to the proximal end of the rotation shaft.

### BRIEF DESCRIPTION OF THE DRAWINGS

FIG. 1 is an external perspective view of a motor device;

FIG. 2 is an external perspective view of the motor device;

FIG. 3 is an external perspective view of an operation jig;

FIG. 4 is an external perspective view of the operation jig;

FIG. 5 is an explanatory view of a method of attaching the operation jig to a cap portion;

FIG. 6 is an explanatory view of the method of attaching the operation jig to the cap portion;

FIG. 7 is an explanatory view of the method of attaching the operation jig to the cap portion;

FIG. 8 is a partial cross-sectional view corresponding to FIG. 5;

FIG. 9 is a partial cross-sectional view corresponding to FIG. 6;

FIG. 10 is a partial cross-sectional view corresponding to FIG. 7;

FIGS. 11A and 11B are enlarged sectional views illustrating the periphery of a movable member;

FIG. 12 is a partial cross-sectional view in a case where the operation jig is attached to the cap portion without fitting the movable member into a

fitting hole;

FIG. 13 is an explanatory view of a first modification;

FIG. 14 is an explanatory view of the first modification;

FIG. 15 is an explanatory view of the first modification;

FIGS. 16A and 16B are explanatory views of the first modification;

FIG. 17 is an explanatory view of a second modification;

FIG. 18 is an explanatory view of the second modification;

FIG. 19 is an explanatory view of the second modification;

FIG. 20 is an explanatory view of the second modification;

FIG. 21 is an explanatory view of a third modification;

FIG. 22 is an explanatory view of the third modification;

FIG. 23 is an explanatory view of a fourth modification;

FIG. 24 is an explanatory view of the fourth modification;

FIG. 25 is an explanatory view of the fourth modification;

FIG. 26 is an explanatory view of the fourth modification;

FIG. 27 is an explanatory view of the fourth modification;

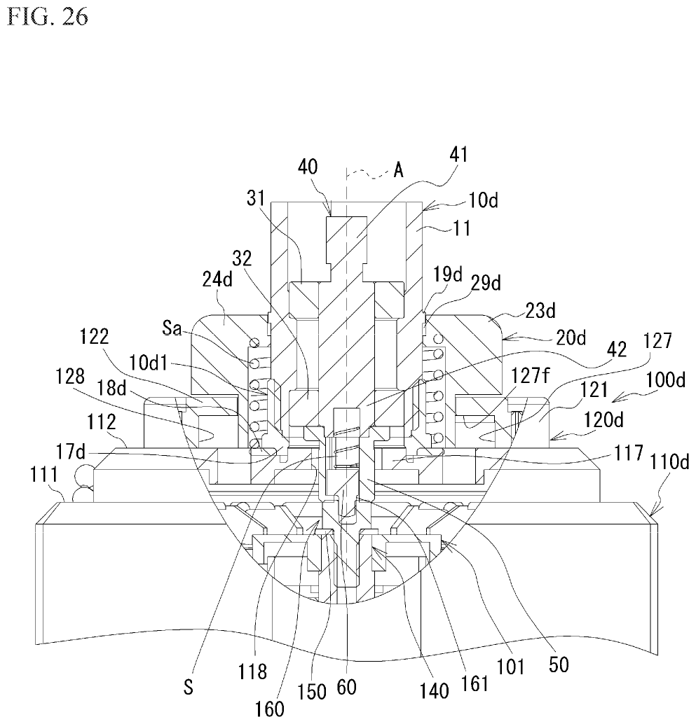

FIG. 26 is an explanatory view of the fourth modification;

FIG. 29 is an explanatory view of the fourth modification;

FIG. 30 is an explanatory view of a fifth modification;

FIG. 31 is an explanatory view of the fifth modification;

FIG. 32 is an explanatory view of the fifth modification; and

FIG. 33 is an explanatory view of the fifth modification.

### DETAILED DESCRIPTION

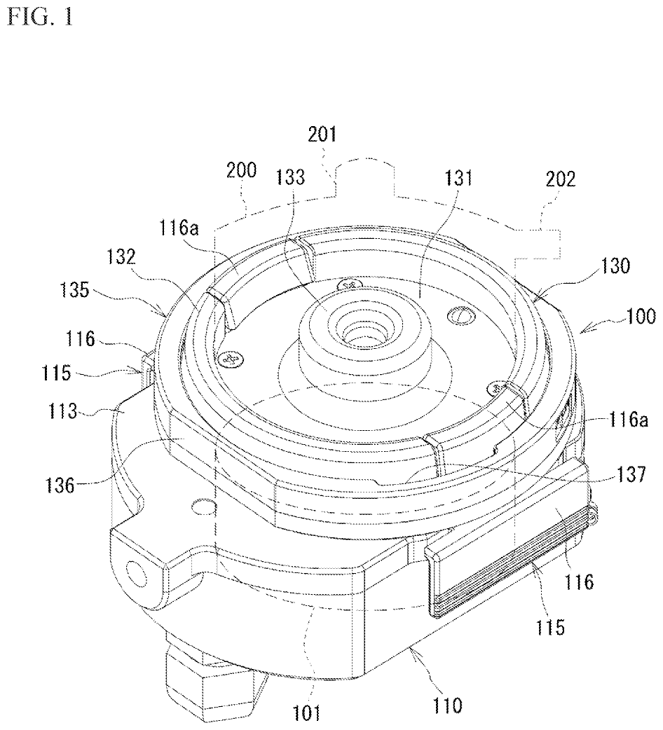

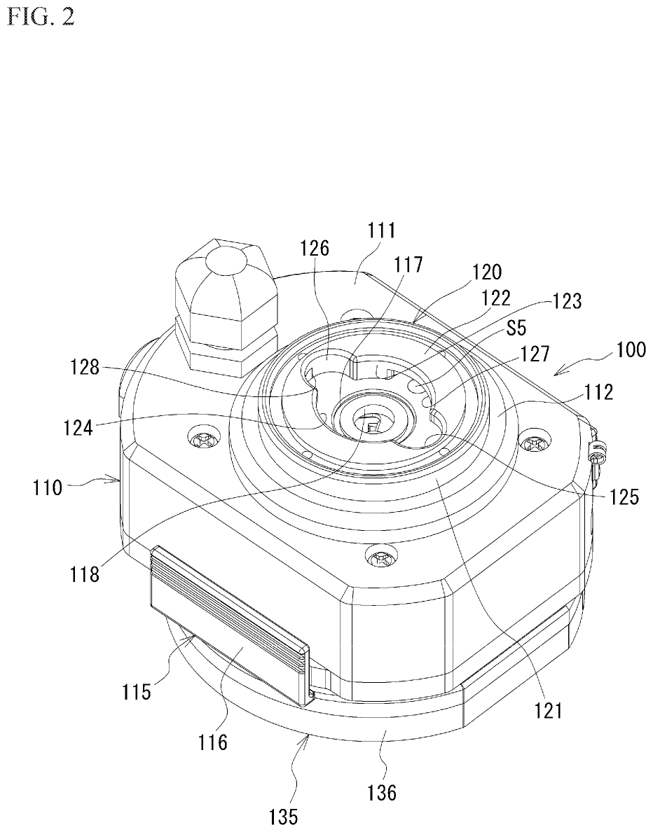

First, a motor device 100 constituting the drive unit will be described. FIGS. 1 and 2 are external perspective views of the motor device 100. The motor device 100 includes a case portion 110, a cap portion 120, and a pump mounting portion 130. The case portion 110 accommodates a motor main body 101 as illustrated in FIG. 1 and is made of, for example, synthetic resin. The case portion 110 includes a proximal end surface 111 and a distal end surface 113 opposed to the proximal end surface 111. A proximal end convex surface 112 is formed on the proximal end surface 111. The cap portion 120 is provided on the proximal end convex surface 112. The cap portion 120 may be made of metal or synthetic resin, for example.

The pump mounting portion 130 is provided on the distal end surface 113. As illustrated in FIG. 1, a pump 200 is mounted on the pump mounting portion 130. The pump mounting portion 130 includes a bottom wall portion 131, rib portions 132, and a magnetic coupling portion 133. The bottom wall portion 131 is formed into a substantially circular shape. The rib portions 132 are formed into an arc shape from a part of the outer peripheral edge of the bottom wall portion 131, and the two rib portions 132 are provided so as to face each other. The two rib portions 132 are provided with a gap therebetween in the circumferential direction. Claw portions 116a described later are positioned in the clearance. An outer periphery of the pump 200 is fitted to an inner side of the rib portion 132. The magnetic coupling portion 133 protrudes in a circular shape from the center portion of the bottom wall portion 131. A magnetic member that rotates together with a rotating shaft 140 of the motor main body 101, which will be described later, is accommodated in the magnetic coupling portion 133. When the magnetic member in the magnetic coupling portion 133 rotates, an impeller in the pump 200 mounted on the pump mounting portion 130 rotates due to the magnetic force between the impeller and the magnetic member.

As illustrated in FIG. 1, a lock ring 135 is fitted to the outer periphery of the pump mounting portion 130. The lock ring 135 includes a ring portion 136 and recessed portions 137. The ring portion 136 has a substantially ring shape. The recessed portions 137 are formed in a part of the inner side surface of the ring portion 136. Although not illustrated in FIG. 1, the recessed portions 137 are formed at two positions of the ring portion 136. Lever portions 115 are respectively provided on both side surfaces of the case portion 110. The lever portion 115 includes a pressing portion 116 and the claw portions 116a. The claw portions 116a extends to a space between the two rib portions 132. The two rib portions 132 and the two claw portions 116a form a circular shape as a whole. The claw portion 116a is formed in a size so as to be accommodated in the recessed portion 137.

The claw portions 116a are engaged with or disengaged from the outer peripheral surface of the pump 200 fitted to the pump mounting portion 130 in accordance with the operation of the pressing portion 116. When the recessed portions 137 are separated from the claw portions 116a in the circumferential direction in a state where the claw portions 116a are engaged with the outer circumferential surface of the pump 200, the claw portions 116a are restricted from being separated from the pump 200 by the ring portion 136. That is, a state in which the claw portions 116a are engaged with the outer circumferential surface of the pump 200 is maintained, and the pump 200 is locked to the motor device 100. In addition, since the positions of the recessed portions 137 in the circumferential direction respectively corresponds to the claw portions 116a, movement of the claw portions 116a into the recessed portions 137 are allowed, and the claw portions 116a are separated from the pump 200. In other words, the pump 200 is unlocked from the motor device 100. In this way, the pump 200 is attached to and detached from the distal end surface 113 of the motor device 100. The pump 200 is formed with an introduction portion 201 extending in the rotational axis direction of the pump 200 and a discharge portion 202 projecting in the tangential direction of the outer periphery.

As illustrated in FIG. 2, the proximal end surface 111 formed with the proximal end convex surface 112 raised at the center thereof. An exposure opening 118 having a substantially circular shape is formed at the center of the proximal end convex surface 112. A guide groove 117 having a substantially annular shape is formed around the exposure opening 118. The cap portion 120 includes an outer peripheral portion 121 and a front surface portion 122. The outer peripheral portion 121 is substantially ring-shaped. The front surface portion 122 located inward from the outer peripheral portion 121. At the center of the front surface portion 122, an attachment and detachment opening 123 that exposes the exposure opening 118 passes through the front surface portion 122.

The attachment and detachment opening 123 includes a circular hole portion 124 and clearance hole portions 125 and 126. The circular hole portion 124 is concentric with the exposure opening 118 and has a diameter larger than that of the exposure opening 118. The clearance hole portion 125 and 126 are continuous with the circular hole portion 124 and are located. radially outward of the circular hole portion 124. The clearance hole portions 125 and 126 face each other across the center of the circular hole portion 124, and each have a smaller diameter than the circular hole portion 24.

Clearance grooves 127 and 128 are formed on a surface side of the front surface portion 122 facing the proximal end convex surface 112. The clearance grooves 127 and 128 extend in a fan-like shape counterclockwise from the clearance hole portions 125 and 126, respectively. Specifically, the clearance groove 127 has a radius equal to the maximum distance from the center of the circular hole portion 124 to the inner surface of the clearance hole portion 125, and has a fan-like shape centered on the center of the circular hole portion 124. The shape of the clearance groove 128 is symmetrical to the shape of the clearance groove 127 with respect to the center of the circular hole portion 124. End surfaces of magnetic bodies S5 and S6, which will be described in detail later, are exposed from portions of the proximal end convex surface 112 located in the clearance grooves 127 and 128. The magnetic bodies S5 and S6 are made of iron, for example, but are not limited thereto.

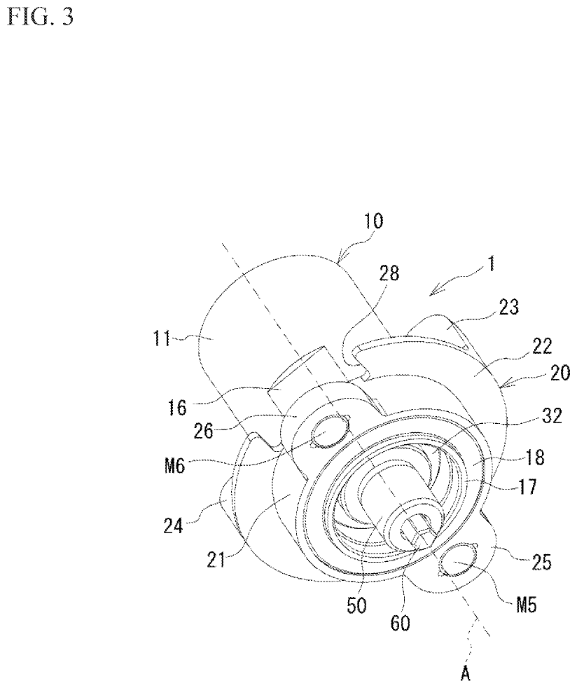

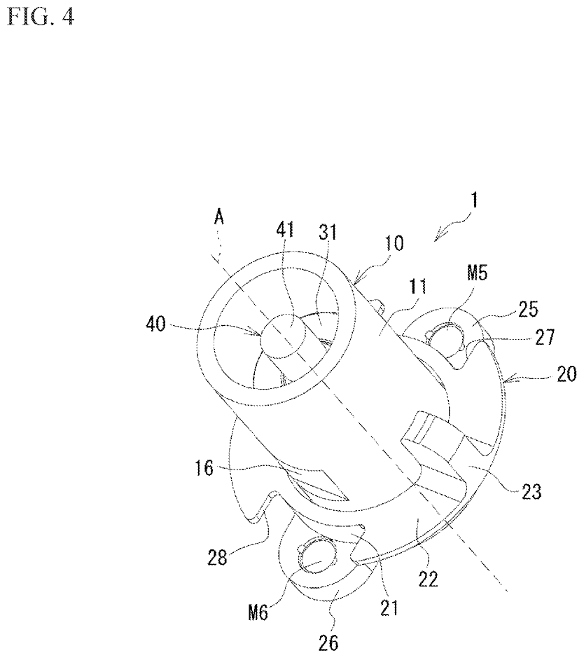

Next, an operation jig 1 constituting the drive unit will be described. FIGS. 3 and 4 are external perspective views of the operation jig 1. The operation jig 1 includes a holder portion 10, a lock portion 20, bearings 31 and 32, an operating shaft 40, a holding member 50, and a movable member 60. FIGS. 3 and 4 illustrate an axis A of the operating shaft 40. The holder portion 10 includes a cylindrical portion 11, a guide protrusion 17, and a stopper 16. The cylindrical portion 11 has a substantially cylindrical shape, holds bearings 31 and 32 therein, and rotatably holds the operating shaft 40 via the bearings 31 and 32. As illustrated in FIG. 4, a proximal end 41 of the operating shaft 40 is exposed from the cylindrical portion 11. The guide protrusion 17 protrudes from the distal end of the cylindrical portion 11 in a substantially annular shape about the axis A. The diameter of the guide protrusion 17 is substantially the same as that of the guide groove 117 illustrated in FIG. 2. The stopper 18 protrudes radially outward from the distal end of the cylindrical portion 11 in a substantially flange shape. The stopper 18 abuts against the lock portion 20 to prevent the lock portion 20 from falling off from the holder portion 10. Recessed portions 15 and 16 are formed in the cylindrical portion 11. The rotation of the holder portion 10 is stopped by engaging, a tool such as a spanner with the recessed portions 15 and 16 when the holder portion 10 is fastened to a flexible shaft to be described later.

The lock portion 20 includes an annular portion 21, a flange portion 22, knob portions 23 and 24, and lock pieces 25 and 26. These members are made of metal, for example, but are not limited thereto, and may be made of synthetic resin. The annular portion 21 is loosely fitted to the outer peripheral surface of the cylindrical portion 11 so as to be rotatable relative to the cylindrical portion 11 about the axis A. The outer diameter of the annular portion 21 is slightly smaller than the inner diameter of the circular hole portion 124 of the attachment and detachment opening 123 of the cap portion 120. Therefore, the annular portion 21 is capable of being inserted into the circular hole portion 124. The flange portion 22 protrudes radially outward from the proximal end side of the annular portion 21 in a substantially circular plate shape. The knob portions 23 and 24 protrude from the annular portion 21 toward the proximal end side of the holder portion 10, and are formed symmetrically about the axis A. The knob portions 23 and 24 are provided for rotating the lock portion 20 about the axis A.

The lock pieces 25 and 26 protrude radially outward from the distal end side of the annular portion 21, are formed at symmetrical positions about the axis A, and protrude from the annular portion 21 in opposite directions about the axis A. Since the outer diameters of the arc-shaped portions of the lock pieces 25 and 26 are slightly smaller than the inner diameters of the clearance hole portions 125 and 126 of the attachment and detachment opening 123, the lock pieces 25 and 26 are insertable into the clearance hole portions 125 and 126, respectively. The thickness of each of the lock pieces 25 and 26 in the direction of the axis A is formed slightly thinner than the height of each of the clearance grooves 127 and 128 from the proximal end convex surface 112 illustrated in FIG. 2. Magnets M5 and M6 are held by the lock pieces 25 and 26, respectively. The magnets M5 and M6 are each disk-shaped and have different polarities on the front side and the rear side. In the flange portion 22, notches 27 and 28 are formed at positions corresponding to the lock pieces 25 and 26, respectively, so that the lock pieces 25 and 26 are visible.

As illustrated in FIG. 3, the ho ding member 50 is fixed to the distal end side of the operating shaft 40. The movable member 60 is held by the holding member 50 so as to be movable back and forth about the axis A. A cross section of the distal end of the movable member 60 perpendicular to the axis A has a regular hexagonal shape.

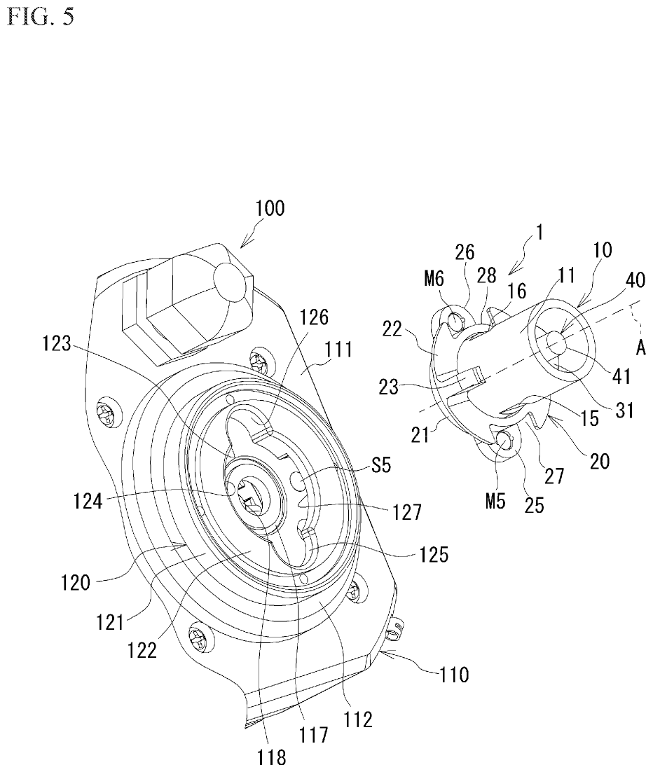

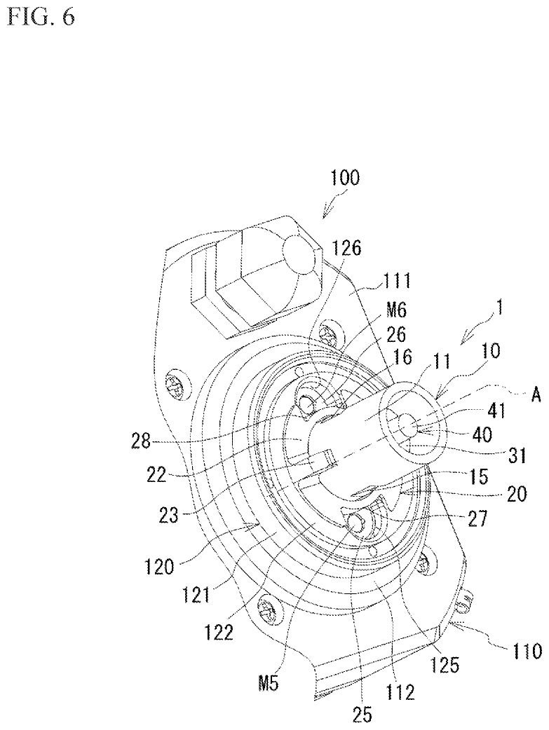

Next, a method of attaching the operation to the cap portion 120 will be described. FIGS. 5 to 7 are explanatory views of a method of attaching the operation to the cap portion 120. As illustrated in FIGS. 5 and the annular portion 21 of the lock port on 20 is positionally aligned with the circular hole portion 124 of the attachment and detachment opening 123, and the lock pieces 25 and 26 of the lock portion 20 are positionally aligned with the clearance hole portions 125 and 126 of the attachment and detachment opening 123, respectively, thereby allowing the operation to be inserted into and removed from the attachment and detachment opening 123. That is, the operation in FIG. 6 is positioned at the unlock position where the lock pieces 25 and 26 are allowed to be inserted into and removed from the attachment and detachment opening 123. In a state in which the operation jig 1 is inserted into the attachment and detachment opening 123, the flange portion 22 abuts against the front surface portion 122 around the attachment and detachment opening 123.

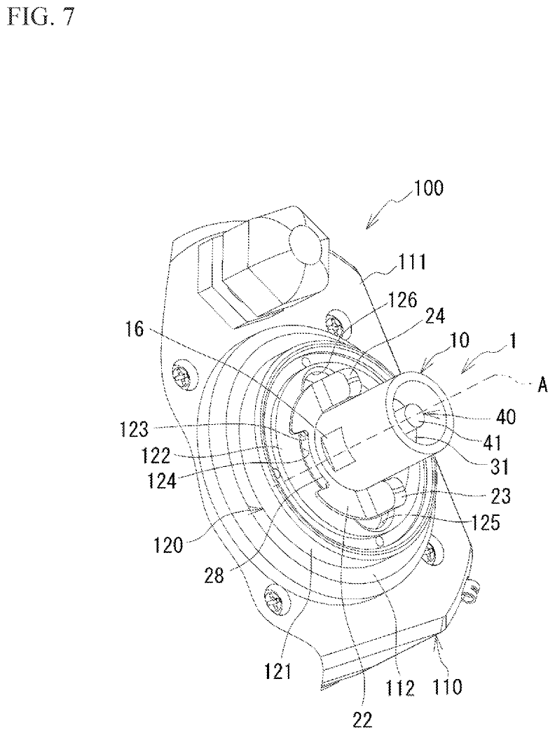

Next, the knob portions 23 and 24 are operated to relatively rotate the lock portion 20 counterclockwise by about 90 degrees with respect to the cap portion 120 as illustrated in FIG. 7. As is result, the lock pieces 25 and 26 move in the clearance grooves 127 and 128, respectively. As a result, the lock pieces 25 and 26 are sandwiched between the proximal end convex surface 112 and the front surface portion 122 in the clearance grooves 127 and 128, respectively, and removal of the lock portion 20 from the attachment and detachment opening 123 is restricted. That is, in FIG. 7, the operation jig 1 is positioned at the lock position where the removal of the lock pieces 25 and 26 from the attachment and detachment opening 123 is restricted. The cap portion 120 thus defines the above-described unlocked and lock positions.

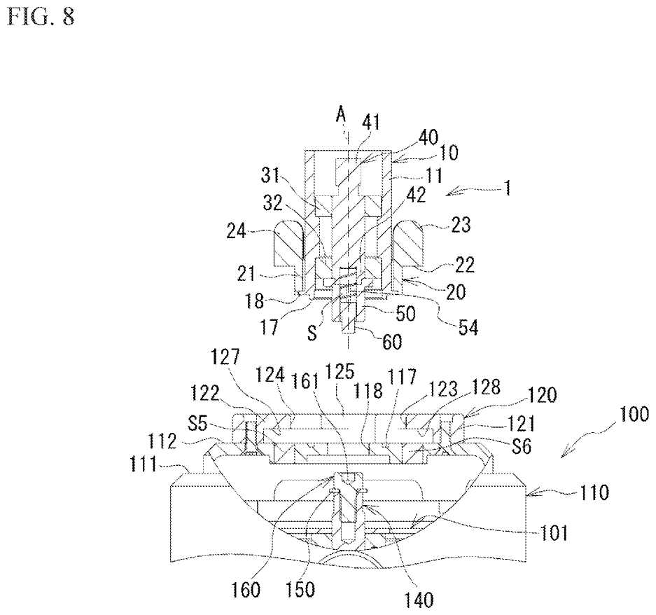

FIGS. 8 to 10 are partial cross-sectional views corresponding to FIGS. 5 to 7, respectively. As illustrated in FIG. 8, the proximal end side of the rotating shaft 140 of the motor main body 101 is hollow, and a bolt 160 is screwed and fixed to the inside of the rotating shaft 140 via a washer 150. A fitting hole 161 is formed in a proximal end which is a head portion of the bolt 160. The cross section of the fitting hole 161 has a shape complementary to the distal end of the movable member 60, and has a regular hexagonal shape like the distal end of the movable member 60. That is, the bolt 160 is a hexagon socket head cap screw. The movable member 60 is biased by a coil spring S, and guide groove portions 54 are formed in the holding member 50, which will be described in detail later.

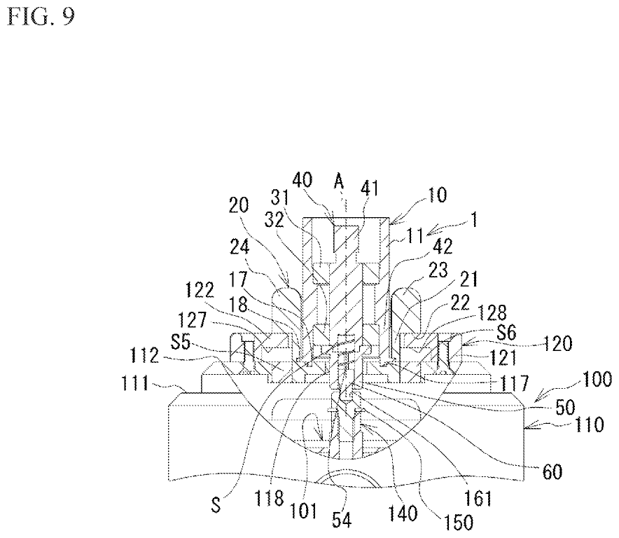

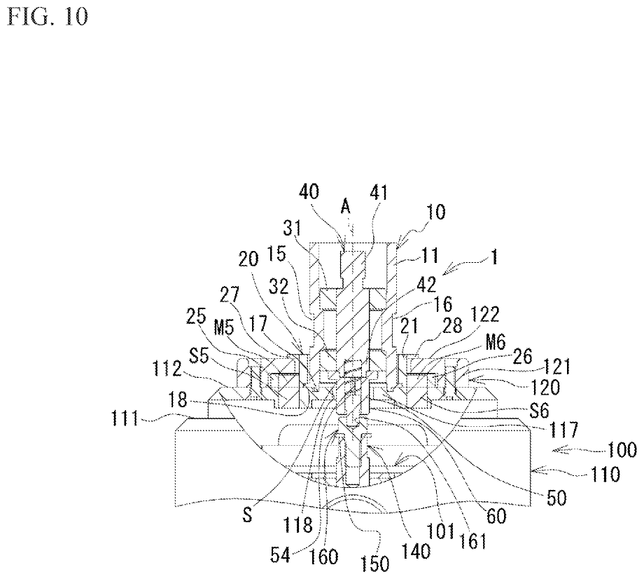

As illustrated in FIGS. 8 and 9, when the distal end of the operation jig 1 is, inserted into the attachment and detachment opening 123 of the can portion. 120, the guide protrusion 17 of the holder portion 10 is engaged with the guide groove 117, and the movable member 60 is inserted and fitted into the fitting hole 161. In this state, when the lock portion 20 is rotated around the axis A such that the guide protrusion 17 rotates in the guide groove 117, the magnets M5 and M6 held by the lock pieces 25 and 26 face the magnetic bodies S5 and 36, respectively, as illustrated in FIG. 10. A magnetic attraction force acts between the magnetic M5 and the magnetic S5 and between the magnetic M6 and the magnetic S6, and the lock pieces 25 and 26 are fixed at the lock position. That is, the lock pieces 25 and 26 are prevented from unintentionally rotating from the lock position to the unlock position. Thus, the operation jig 1 is prevented from failing out of the attachment and detachment opening 123. The lock pieces 25 and 26 holding the magnets M5 and M6 as described above have functions of restricting removal of the operation jig 1 from the attachment and detachment opening 123 at the lock position and fixing the lock pieces 25 and 26 at the lock position, and thus the functions are integrated.

The magnets M5 and M6 and the magnetic bodes 35 and 36 are examples of a magnetic attraction mechanism.

As illustrated in FIGS. 7 to 9, in a state where the operation jig 1 is inserted into the attachment and detachment opening 123, the flange portion 22 comes into contact with the front surface portion 122. Accordingly, the operation jig 1 is prevented from being inclined with respect to the cap portion 120. Therefore, it is possible to prevent a load from being applied to the operating shaft 40 or the like due to the inclination of the operation jig 1 in a state where the movable member 60 and the fitting hole 161 are fitted to each other. Further, by engaging the guide protrusion 17 with the guide groove 117, the position of the operation jig 1 with respect to the proximal end convex surface 112 is defined, and the movable member 60 and the fitting hole 161 are capable of being smoothly fitted to each other.

In a state in which the operation jig 1 is attached to the cap portion 120 as described above, a flexible shaft connected to a manual handle that generates force by being manually rotated at the time of power failure or the like is connected to the proximal end side of the operation jig 1. This, causes the operating shaft 40 to rotate. In this way, the rotational force of the operating shaft 40 is transmitted to the rotation shaft 140 via the holding member 50, the movable member 60, and the bolt 160 to manually drive the pump 200. As described above, the lock portion 20 is engaged with the holder portion 10 so as to be rotatable relative thereto. For example, when the flexible shaft is connected to the proximal end side of the operation jig 1 in a state where the operation jig 1 is attached to the cap portion 120 as illustrated in FIG. 10, even if the holder portion 10 is rotated by mistake, the lock portion 20 is held at the lock position. Thus, the connection workability is also improved.

A female screw portion (not illustrated) is formed the cylindrical portion 11 of the holder portion 10, and a male screw portion is formed on the flexible shaft. The holder portion 10 and the flexible shaft are connected to each other by screwing these screw portions. On the other hand, since the holder portion 10 is engaged with the lock portion so as to be rotatable relative to the lock portion 20, it is needed to prevent rotation only by the holder portion 10 when the flexible shaft is connected. Therefore, a tool such as a spanner is engaged with the recessed portions 15 and 16 formed in the cylindrical portion 11 to stop the rotation of the holder portion 10, thereby connecting the flexible shaft and the holder portion 10.

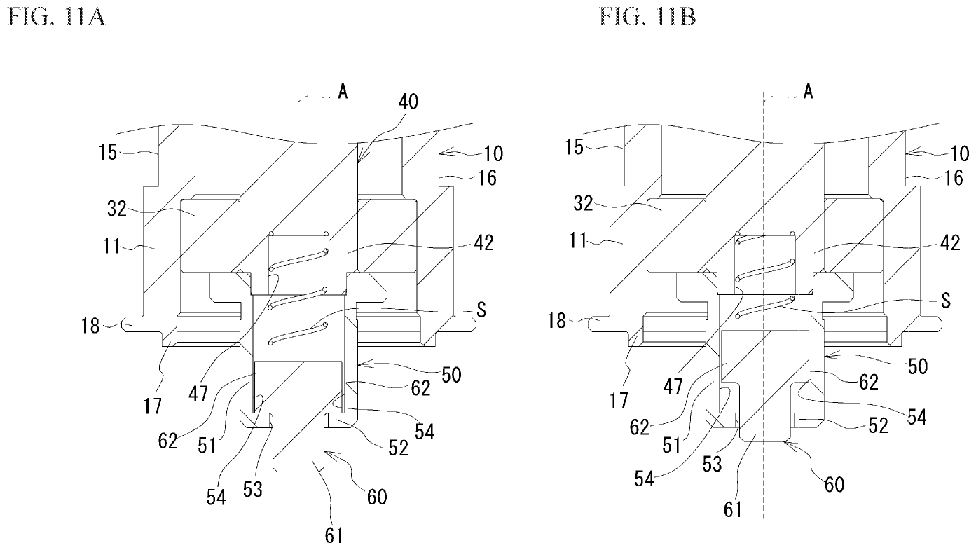

Next, a structure in which the movable member 60 is movable forward and backward in the direction of the axis A will be described. FIGS. 11A and 11B are enlarged cross-sectional views illustrating the periphery the movable member 60. In FIGS. 11A and 11B, the lock potion 20 is omitted. As illustrated in FIG. 11A, a hole 47 extending along the axis A is formed in a distal end 41 of the operating shaft 40. The holding member 50 is fixed to the distal end 42. The holding member 50 includes a cylindrical portion 51, a distal end portion 52, an opening 53, and the guide groove portions 54. The cylindrical portion 51 is formed in a cylindrical shape. The distal end portion 52 protrudes inward from the distal end of the cylindrical portion 51. The opening is formed in a circular shape in the distal end portion 52. The two guide groove portions 54 extend in the direction of the axis A inside the opening 53 and are provided symmetrically with respect to the axis A.

The movable member 60 includes a hexagonal portion 61 and guide pieces 62. As described above, the hexagonal portion 61 has a hexagonal cross section. The distal end of the hexagonal portion 61 protrudes from the opening 53. The two guide pieces 62 protrude outward in the radial direction from the proximal end side of the hexagonal portion 61 and are provided symmetrically with respect to the axis A. The guide pieces 62 are slidably engaged with the guide groove portions 54 extending along the axis A. Thus, the movable member 60 is held so as to be movable along the axis A in the holding member 50, and the relative rotation of the movable member 60 around the axis A with respect to the holding member 50 is restricted. That is, the movable member 60 rotates integrally with the operating shaft 40 and the holding member 50. Further, the guide pieces 62 and the distal end portion 52 come into contact with each other, so that the movable member 60 is prevented from falling off from the holding member 50.

The proximal end side of the coil spring S is inserted into the hole 47. The distal end of the coil spring S urges the proximal end of the hexagonal portion 61. For example, when a pressing force against the urging force of the coil spring S acts on the movable member 60, as illustrated in FIG. 11B, the coil spring S contracts and the movable member 60 moves backward along the axis A in the holding member 50. When such a pressing force is released, the movable member 60 move forward along the axis A in accordance with the urging force of the coil spring S again.

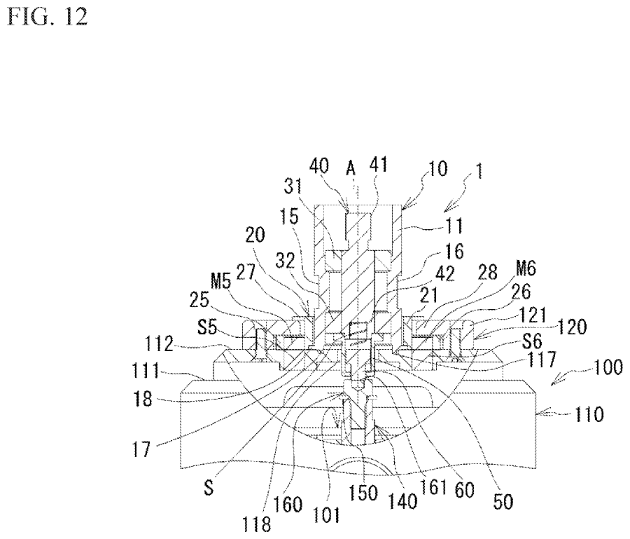

FIG. 12 is a partial cross-sectional view when the operation is attached to the cap portion 120 without the movable member 60 being fitted into the fitting hole 161. As illustrated in FIG. 12, the movable member 60 is not fitted into the fitting hole 161, and the movable member 60 pressed by the bolt 160 against the urging force of the coil spring S and moves backward. That is, the movable member 60 is positioned at an unfitting position with respect to the fitting hole 161. Also in this case, when the operating shaft 40 rotates, the movable member 60 rotates with respect to the fitting hole 161 and is positioned at a fitting position, and the movable member 60 is inserted and fitted into the fitting hole 161 in accordance with the biasing force of the coil spring S. In this way, possible to easily attach the operation jig 1 to the cap portion 120, and to manual operate the pump 200.

Although the coil spring S is illustrated as an example of the first biasing member, a plate-shaped spring may be used instead of the coil spring The operating shaft 40 and the holding member 50 may be integrally formed.

Although the lock pieces 25 and 26 hold the magnets M5 and M6, respectively, it is sufficient that at least one of the lock pieces 25 and 26 holds the magnets and a magnetic body, that generates a magnetic attraction force with the magnets at the lock position is provided on the case portion 110. Further, at least one of the lock pieces 25 and 26 may hold a magnetic body, and a magnet may e provided on the case portion 110. However, if a magnet is provided on the case portion 110, there is a concern that driving of the motor main body 101 may be affected. Therefore, it is preferable to provide a magnetic body on the case portion 110.

The cross sections of the movable member 60 and the fitting hole 161 are both regular hexagonal shapes, but are not limited thereto, and may be polygonal shapes, for example, regular polygonal apes such as regular triangular shapes and regular quadrangular shapes, or elliptical shapes as long as they are complementary shapes and are other than circular shapes. The movable member 60 and the fitting hole 161 may have any cross-sectional shape as long as the movable member 60 and the fitting hole 161 are capable of being coupled to each other to transmit rotational force.

Although the case portion 110 and the cap portion 120 are manufactured separately and fixed to each other, the present invention is not limited not limited thereto, and they may be integrally formed of the same material. Although the operating shaft 40 and the holding member 50 are manufactured separately and fixed to each other, the operating shaft 40 and the holding member 50 are not limited thereto, and may be integrally formed of the same material. The holder portion 10 and the lock portion 20 are manufactured separately and are loosely fitted to each other. However, the present invention is not limited thereto, and the holder portion 10 and the lock portion 20 may be integrally formed of the same material. Although the rotating shaft 140 and the bolt 160 are manufactured separately and fixed to each other, the present invention is not limited thereto, and they may be integrally formed of the same material.

The clearance grooves 127 and 128 may not extend counterclockwise from the clearance hole portions 125 and 126, respectively, but may extend clockwise in a fan-like shape.

Next, a plurality of modifications will be described. In a plurality of modifications described below, the clearance grooves 127 and 128 extend in a fain-like shape in the clockwise direction from the clearance hole portions 125 and 126, respectively. In the following modifications, the magnets M5 and M6 and the magnetic bodies S5 and S6 are not provided.

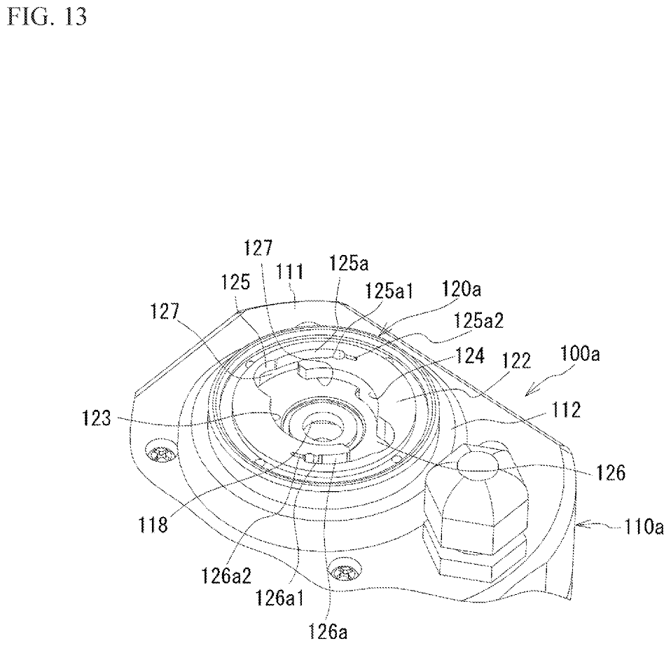

FIGS. 13 to 16B are explanatory views of a first modification. As illustrated in FIG. 13, a cap portion 120a attached to a case portion 110a of a motor device 100a is formed with guide grooves 125a and 126a continuing clockwise from the clearance hole portions 125 and 126, respectively. Each of the guide grooves 125a and 126a has an arc shape. Protruding portions 125a1 and 126a1 are formed at distal ends of the guide grooves 125a and 126a, respectively. The guide groove 125a has an inner surface on the radially inner side and an inner surface on the radially outer side that are opposed to each other. The protruding portion 125a1 protrudes radially outward from the inner surface on the radially inner side. The same applies to the protruding portion 126a1. Further, slits 125a2 and 126a2 are continuous with the distal ends of the guide grooves 125a and 126a in the clockwise direction. The slit 125a2 is narrower in the radial direction than the guide groove 125a, and shorter in the circumferential direction than the guide groove 125a. The same applies to the slit 126a2.

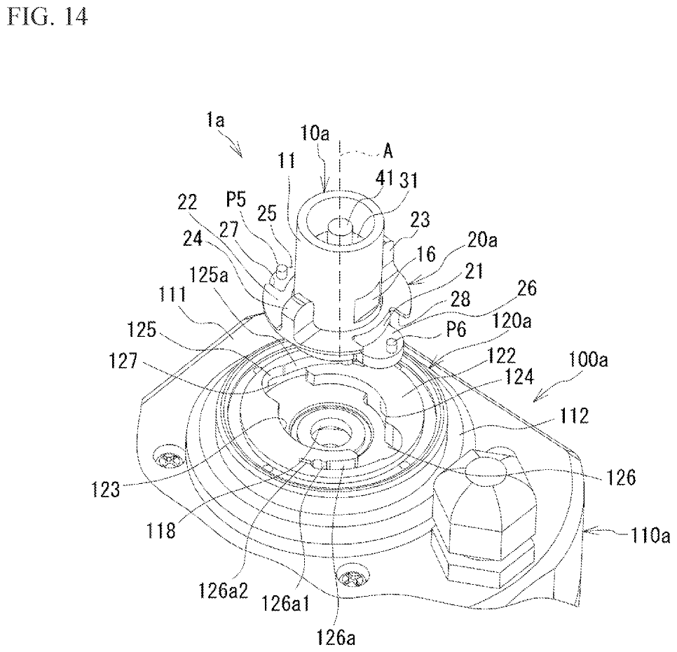

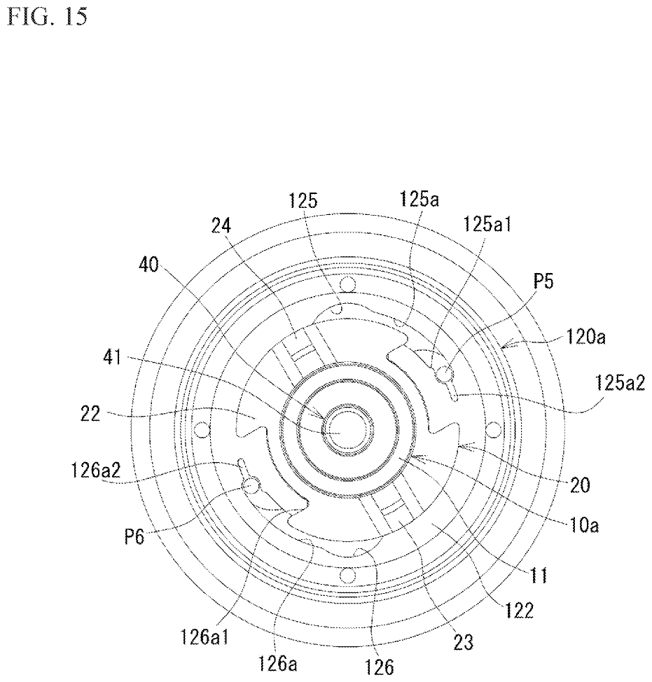

As illustrated in FIG. 14, the lock pieces 25 and 26 of the lock portion 20a of an operation jig la are respectively provided with pins P5 and P6 protruding toward the proximal end side of the operation jig 1a in in the direction of the axis A. When the lock portion 20a is attached to the attachment and detachment opening 123 and rotated in the clockwise direction, the pins P5 and P6 move in the guide grooves 125a and 126a, respectively. As illustrated in FIG. 15, the pins P5 and P6 ride over the protruding portions 125a1 and 126a1, respectively, and are positioned at the distal ends of the guide grooves 125a and 126a. In this way, the pins P5 and P6 engage with the protruding portions 125a1 and 126a1, respectively. As a result, the lock pieces 25 and 26 are fixed in the lock position.

When the pin P5 moves over the protruding portion 125a1, the periphery of the protruding portion 125a1 is elastically deformed such that the guide groove 125a is widened. At this time, the slit 125a2 is elastically deformed so as to be widened. That is, the slit 125a2 is provided to facilitate the elastic deformation of the cap portion 120a around the protruding portion 125a1. Thereby, the slit 125a2 is elastically deformed such that the protruding portion 125a1 and the pin P5 are engaged with and disengaged from each other. The same applies to the slit 126a2. The protruding portions 125a1 and 126a1 are an example of a first engagement portion. The pins P5 and. P6 are examples of a second engagement portion. The slits 125a2 and 126a2 are examples of the easily deformable portion.

The guide grooves 125a and 126a are formed in the cap portion 120a, and the pins P5 and P6 protrude from the lock pieces 25 and 26, respectively, toward the proximal end side of the operation jig 1a, but the present invention is not limited thereto. For example, two guide grooves may be formed in the proximal end convex surface 112 of the case portion 110, and pins protruding from the lock pieces 25 and 26 toward the distal end side of the operation jig 1a may be provided. Further, the present invention is not limited to two guide groves and two pins, and one guide groove and one pin may be provided.

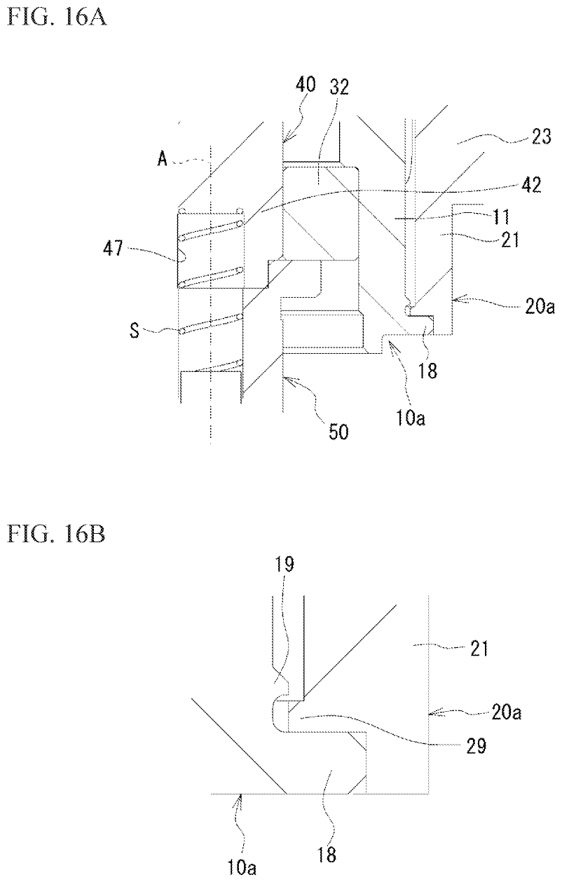

FIG. 16A is a partial cross-sectional view of the operating jig 1a. FIG. 16B is an enlarged view of FIG. 16A. On the cylindrical portion 11 of a holder portion 10a, a protrusion 19 is formed closer to the proximal end side of the cylindrical portion 11 than the stopper 18 and in the vicinity of the stopper 18.

The protrusion 19 protrudes radially outward from the cylindrical portion 11 and extends in the circumferential direction of the cylindrical portion 11. At the distal end of the annular portion 21 of the lock portion 20a, a protrusion 29 is formed which is held between the stopper 18 and the protrusion 19. The protrusion 29 protrudes radially inward from the annular portion 21 and extends in the circumferential direction of the annular portion 21. The protrusion 29 is press-fitted between the protrusion 19 and the stopper 18. As a result, it is possible to prevent the lock portion 20a from coming off the holder portion 10a.

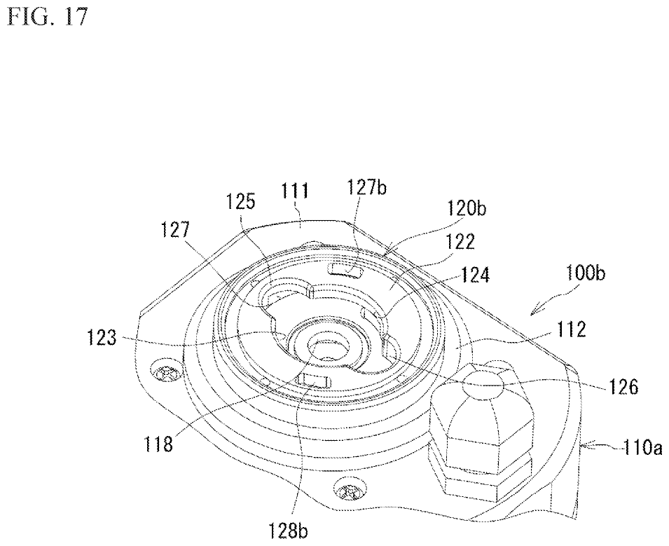

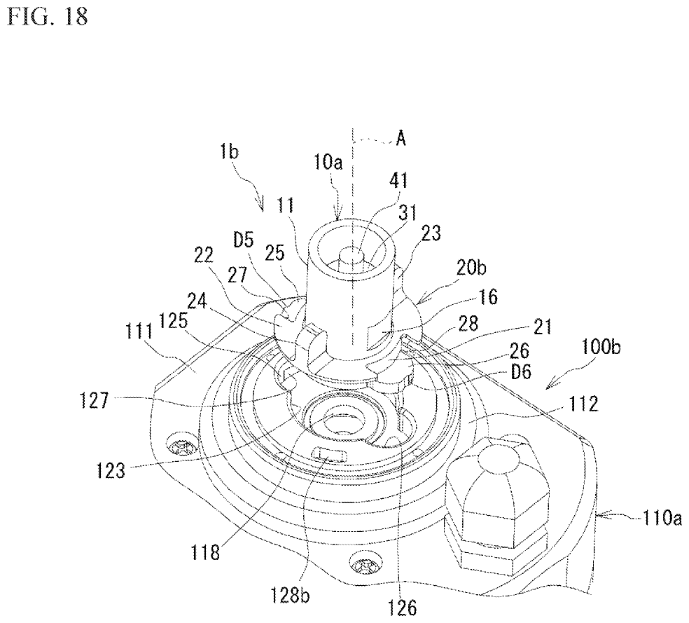

FIGS. 17 to 20 are explanatory views of a second modified example. As illustrated in FIG. 17, hole portions 127b and 128b are formed in a cap portion 120b of a motor device 100b. As illustrated in FIG. 18, recessed portions D5 and D6 are formed in the lock pieces 25 and 26 of a lock portion 20b, respectively The recessed portion D5 and D6 are recessed radially inward.

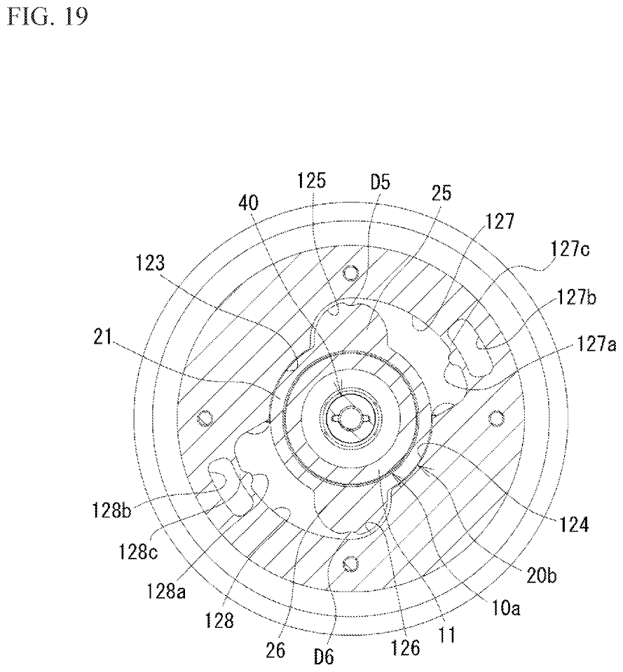

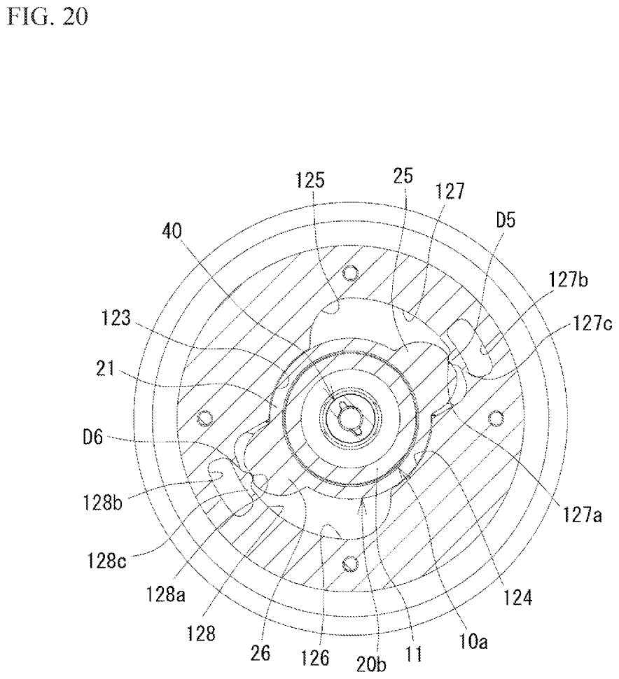

FIGS. 19 and 20 are cross-sectional views perpendicular to the axis A. FIG. 19 illustrates a state in which the lock pieces 25 and 26 are at the unlock position, and FIG. 20 illustrates a state in which the lock pieces 25 and 26 are at the lock position. As illustrated in FIGS. 19 and 20, protruding portions 127a and 128a are formed to protrude radially inward from the clearance grooves 127 and 128, respectively. At the lock position, the protruding portions 127a and 128a engage the recesses D5 and D6, respectively. The holes portions 127b and 128b face the protruding portions 127a and 128a, respectively, in the radial direction. Accordingly, a thin portion 127c between the hole portion 127b and the inner side surface of the clearance groove 127 is thin. Accordingly, the thin portion 127c is easily elastically deformed toward the hole portion 127b, in other words, radially outward.

When the recessed portion P5 is engaged with and disengaged from the protruding portion 127a, the thin portion 127c is elastically deformed so as to move radially outward. That is, the thin portion 127c is elastically deformed such that the protruding portion 127a and the recessed portion D5 are engaged with and disengaged from each other. The same applies to the thin portion 128c. The protruding portions 127a and 128a are an example of a first engagement portion. The recessed portions D5 and D6 are an example of a second engagement portion. The hole portions 127b and 128b are examples of the easily deformable portion.

The recessed portions D5 and P6 are formed in the lock pieces 25 and 26, respectively, and the protruding portions 127a and 128a and the hole portions 127b and 128b are formed in the cap portion 120b, but the present invention is not limited thereto. For example, a recessed portion may be formed in the cap portion 120b, and a protruding portion and a hole may be formed in each of the lock pieces 25 and 26.

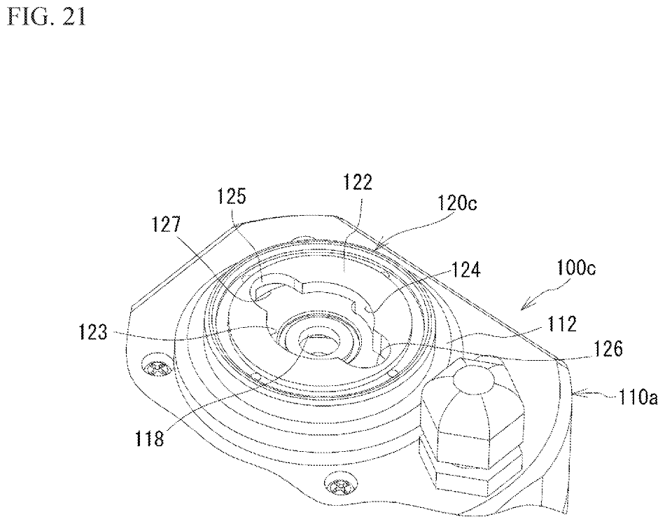

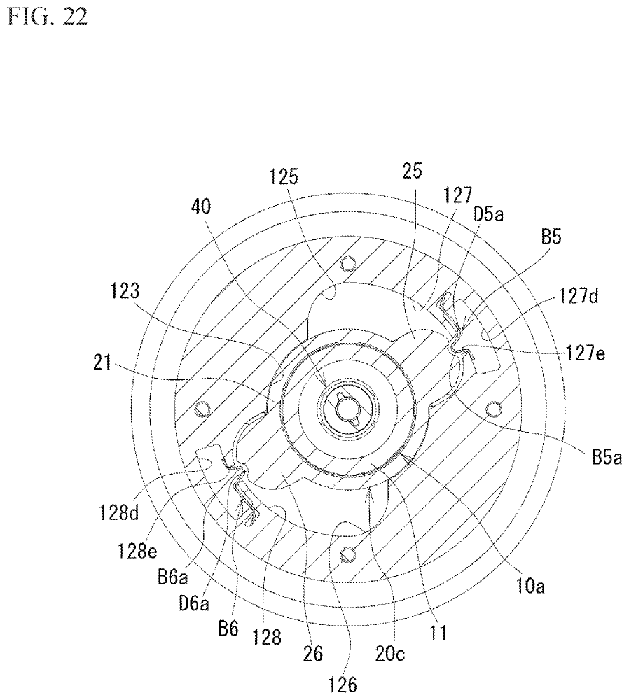

FIGS. 21 and 22 are explanatory views of a third modified example. In a cap portion 120c, accommodation portions 127d and 128d are formed radially outside the clearance grooves 127 and 128, respectively. The accommodation portions 127d and 128d are formed on a surface of the front surface portion 122 facing the proximal end convex surface 112. Therefore, as illustrated in FIG. 21, the accommodation portions 127d and 128d are not be visually recognized from the appearance. As illustrated in FIG. 22, the accommodating portions 127d and 128d are formed with communication holes 127e and 128e which are open to the inner side surfaces of the clearance grooves 127 and 128, respectively. The late springs B5 and B6 are accommodated in the accommodating portions 127d and 128d, respectively. The proximal ends of the plate springs B5 and B6 are held by the cap portion 120c. Further, the plate springs B5 and B6 are respectively formed with bent portions B5a and B6a which are bent between the proximal end and the distal end. The bent portions B5a and 36a protrude radially inward from the communication holes 127e and 128e, respectively. At the lock position, the angled portions B5a and boa engage the recessed portions D5a and D6a, respectively.

When the recessed portion D5a is engaged with or disengaged from the bent portion B5a, the plate spring B5a is elastically deformed such that the bent portion B5 moves radially outward. The same applies to the bent portion B6a. The bent portions B5a and B6a are an example of a first engagement portion. The recessed portions D5a and D6a are an example of a second engagement portion.

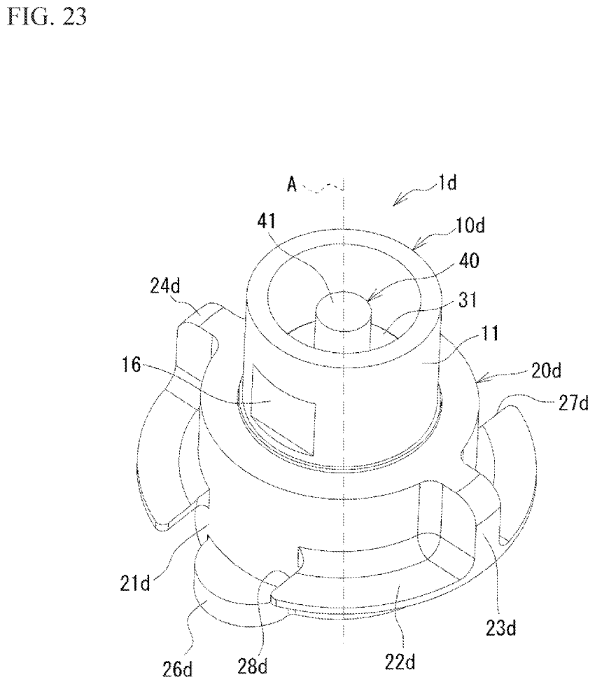

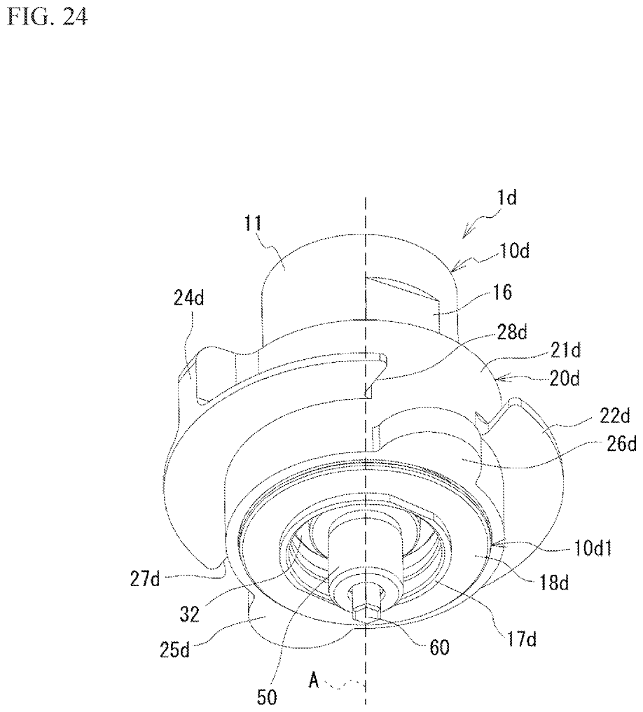

FIGS. 23 to 29 are explanatory views of a fourth modified example. As illustrated in FIGS. 23 and 24, an annular portion 21d of a lock portion 20d is longer than the annular portion 21 in the axial direction A and has a larger outer diameter than the annular portion 21 in the present embodiment described above. On the outer peripheral surface of the annular portion 21d, lock pieces 25d and 26d, a flange portion 22d, and knob portions 23d and 24d are provided. Notches 27d and 28d are formed in the flange portion 22d.

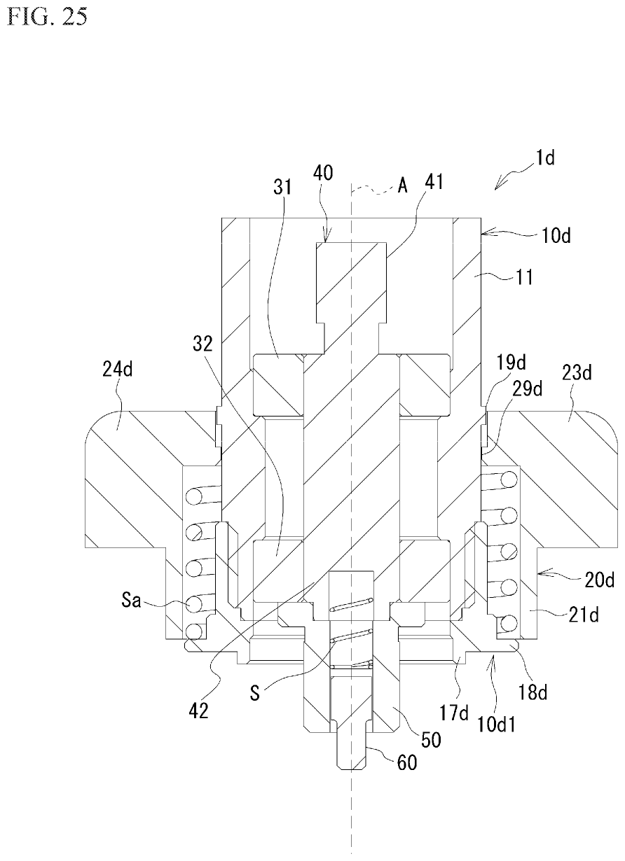

As illustrated in FIG. 25, a coil spring Sa is provided between the inner circumferential surface of the annular portion 21d and the outer circumferential surface of a holder portion 10d. Further, a holding cylinder 10d1 having a cylindrical shape is fitted to the distal end of the holder portion 10d. A stopper 18d is formed at the distal end of the holding cylinder 10d1. A protrusion 19d is formed in the middle of the cylindrical portion 11 of the holder portion 10d. The protrusion 19d protrudes radially outward from the cylindrical portion 11 and extends in the circumferential direction of the cylindrical portion 11. The coil spring Sa is disposed between the stopper 18d and a protrusion 29d.

The protrusion 29d is formed in the vicinity of the proximal end of the annular portion 21d of the lock portion 20d. The protrusion 29d protrudes radially inward from the annular portion 21d and extends in the circumferential direction of the annular portion 21d. The protrusion 29d is located closer to the distal end side than the protrusion 19d. Accordingly, it is possible to prevent the holder portion 10d from falling off from the proximal end side of the lock portion 20d.

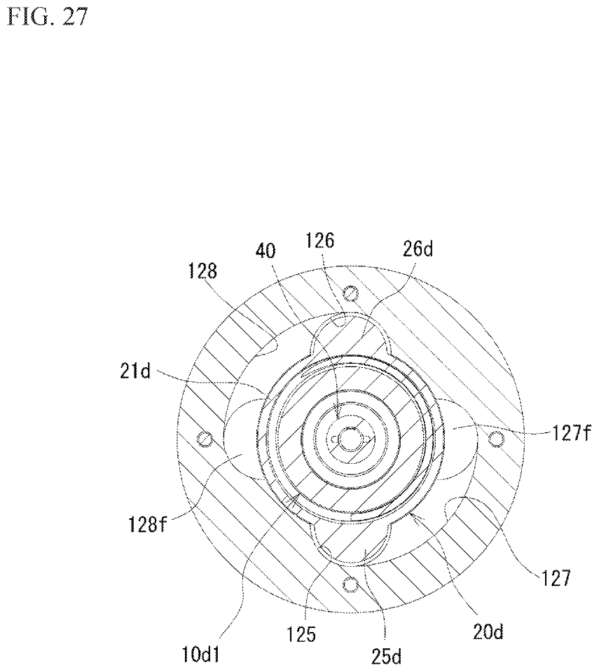

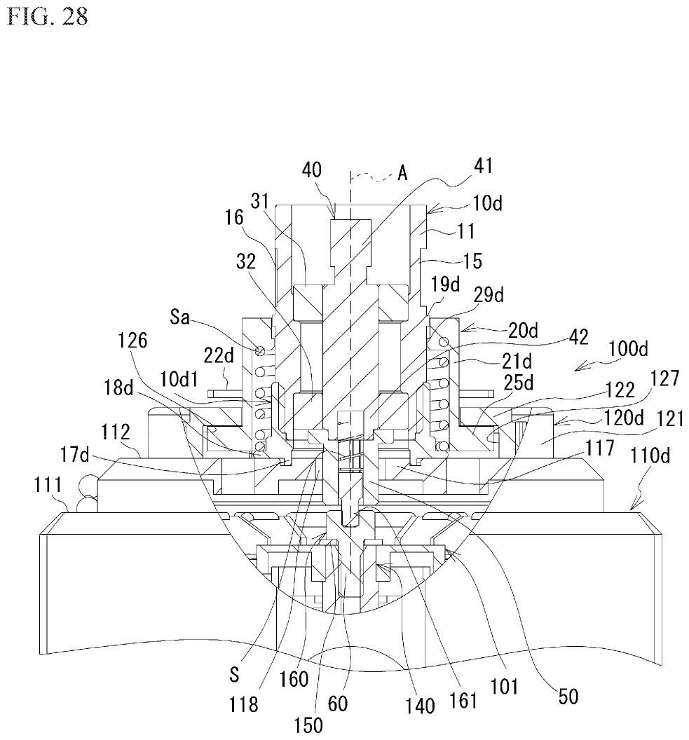

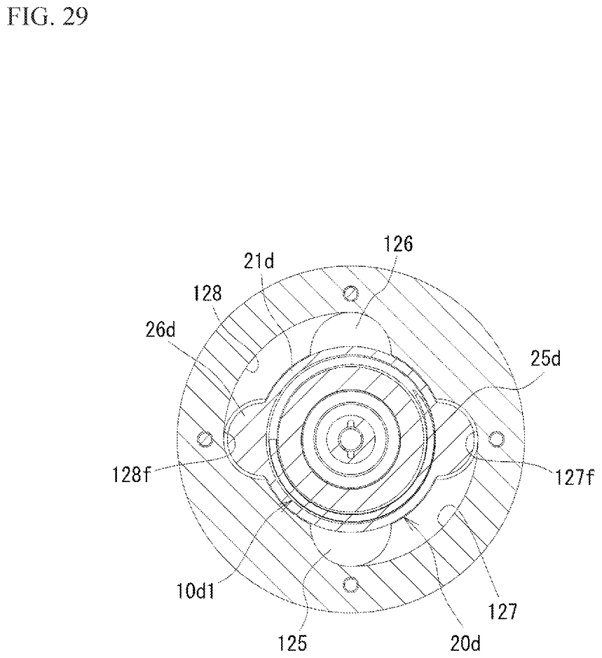

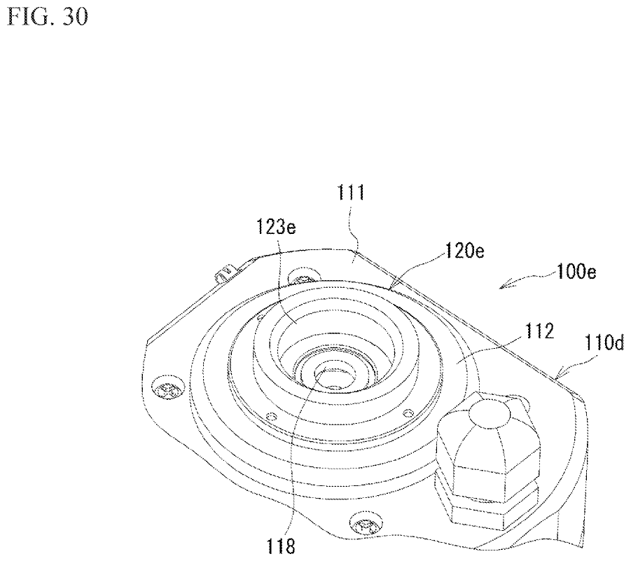

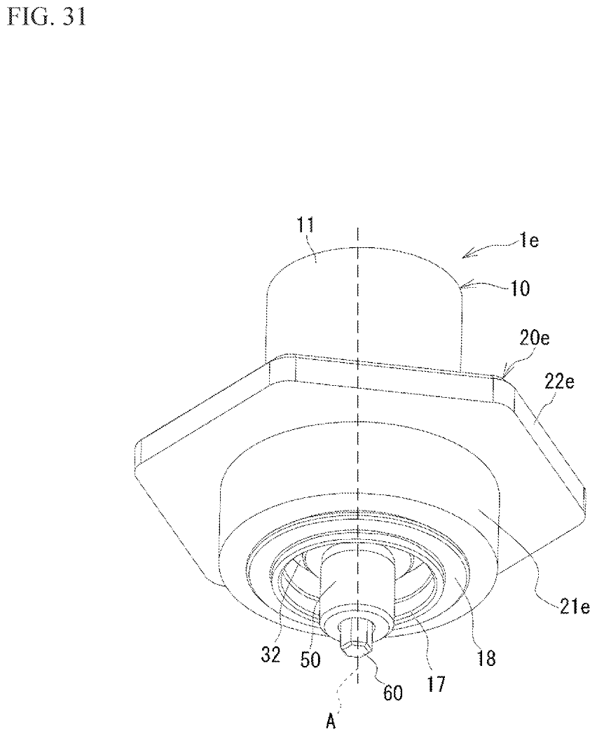

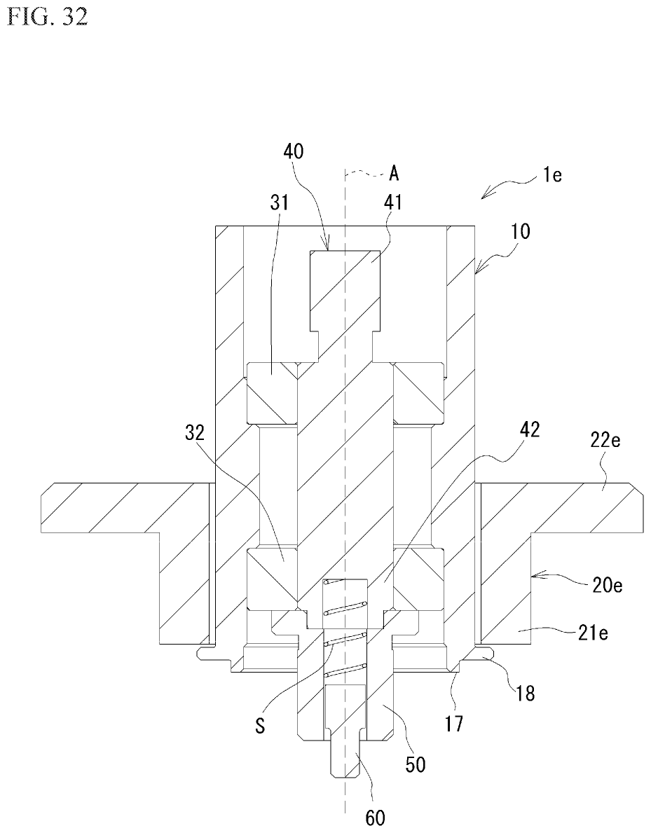

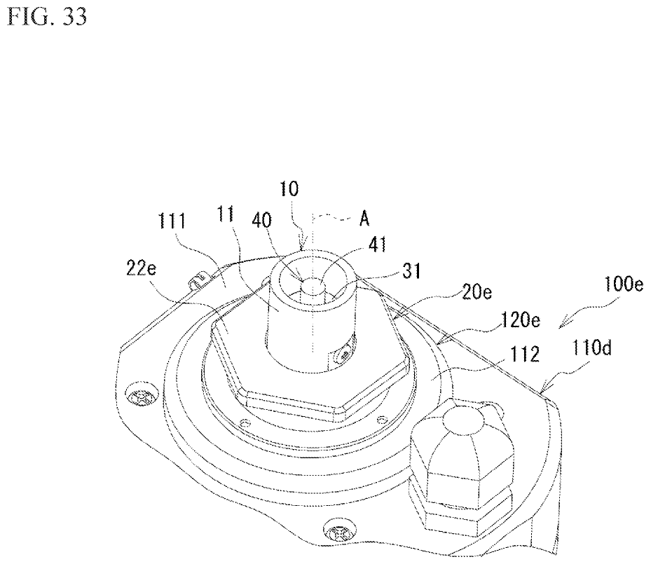

As illustrated in FIGS. 26 and 27, the lock pieces 25d and 26d are respectively inserted into the clearance hole portions 125 and 126 of a cap portion 120d, and the distal end of the annular portion 21d comes into contact with the proximal end convex surface 112. In this state, the coil spring Sa is sandwiched and compressed between the stopper 18d and the protrusion 29d. FIG. 27 illustrates a surface side of the front surface portion 122 of the cap portion 120d, and recessed portions 127f and 128f recessed from the clearance grooves 127 and 128 are formed at the respective ends of the clearance grooves 127 and 128 on the back surface side. While the distal end of the annular portion 21d is in contact with the proximal end convex surface 112, the lock portion 20d is rotated to the lock position to release the lock portion 20d. Then, as illustrated in FIGS. 28 and 29, the distal end of the annular portion 21d is spaced away from the proximal end convex surface 112 by the urging force of the coil spring Sa, and the lock pieces 25d and 26d are pressed against the recessed portions 127f and 128f. As a result, the lock pieces 25d and 26d are fixed at the lock position. The coil spring Sa is an example of a second biasing member. The holder portion 10d and the holding cylinder 10d1 may be integrally formed.

FIGS. 30 to 33 are explanatory views of a fifth modification example. As illustrated in FIG. 28, a female screw portion (not illustrated) is formed on the inner peripheral surface of an attachment and detachment opening 123e of a cap portion 120e fixed to a case portion 110e of a motor device 100e. In FIGS. 29 and 30, a flange portion 22e of a lock portion 20e of an operation jig 1e is formed in a substantially regular hexagonal shape. A male screw portion (not illustrated) is formed on an outer peripheral surface of an annular portion 21e. As illustrated in FIG. 33, when the attachment and detachment opening 123e and the annular portion 21e are screwed together, the operation jig 1e is fixed to the cap portion 120e. At the time of screwing, the lock portion 20e is easily rotated by rotating the flange portion 22e having a substantially regular hexagonal shape. The attachment and detachment opening 123e and the annular portion 21e are examples of a screw portion. The flange portion 22e is not limited to the above-described shape, and may be, for example, a polygonal shape such as a quadrangular shape, a circular shape, or an elliptical shape.

While the exemplary embodiments of the present disclosure have been illustrated in detail, the present disclosure is not limited to the above-mentioned embodiments, and other embodiments, variations and variations may be made without departing from the scope of the present disclosure.

What is claimed is:

1. A drive unit comprises:
a motor device including:
a motor main body;
a case portion accommodating the motor main body, a pump driven by the motor main body being attachable to the case portion; and
a cap portion provided on the case portion; and
an operation jig attachable to and detachable from the cap portion,
wherein
the case portion is formed with an exposure opening through which a proximal end of a rotation shaft of the motor main body is exposed, and
the cap portion includes as attachment and detachment opening through which the exposure opening is exposed, and
the operation jig includes:
a holder portion formed into a cylindrical shape;
an operating shaft rotatably held in the holder portion; and
a movable member that rotates in conjunction with the operating shaft and is held by the operating shaft so as to be movable forward and backward from a distal end of the operating shaft in a direction of an axis of the operating shaft;
a first biasing member biases the movable member away from the operating shaft in a direction of the axis,
the proximal end of the rotation shaft and the movable member formed into complementary shapes to be positioned at an unfitting position where the rotation shaft and the operating shaft are not fitted to each other or a fitting position where the rotation shaft and the operating shaft are fitted to each other in accordance with relative rotation of the rotation shaft and the operating shaft around the axis in a state where the operation is attached to the attachment and detachment opening,
at the unfitting position, the movable member is pressed against the proximal end of the rotation shaft against a biasing force of the first biasing member, and
at the fitting position, the movable member is biased by the first biasing member to be fitted to the proximal end of the rotation shaft.

2. The drive unit according to claim wherein
the operation jig includes a lock piece that protrudes outward in a radial direction about the a and
the can portion defines an unlock position and a lock position,
the unlock position allows insertion and removal of the lock piece into and from the attachment and detachment opening, and
the lock position restricts removal of the lock piece from the attachment and detachment opening by relatively rotating the lock piece and the cap portion about the axis from the unlock position in a state in which the lock piece is inserted into the attachment a detachment opening.

3. The drive unit according to claim 2, wherein the lock piece and the case portion include a magnetic attraction mechanism that attracts each other by magnetic force at the lock position.

4. The drive unit according to claim 2, wherein
at least one of the cap portion and the case portion includes a first engagement portion, and
the lock piece includes a second engagement portion that engages with the first engagement portion at the lock position.

5. The drive unit according to claim 4, wherein at least one of the cap portion, the case portion, and the lock piece includes a easily deformable portion that is easily elastically deformed such that the first and second engagement portions are engageable with and disengageable from each other.

6. The drive unit according to claim 4, wherein one of the first and second engagement portions is elastically deformable so as to be engageable with and disengageable from each other.

7. The drive unit according to claim 2, wherein the operation jig includes a second biasing member that biases the lock piece such that the lock piece is pressed against the cap portion at the lock position.

8. The drive unit according to claim 2, wherein
the operation jig includes an annular portion loosely fitted to an outer periphery of the holder portion so as to be relatively rotatable about the axis, and
the lock piece protrudes radially outward from the annular portion.

9. The drive unit according to claim 8, wherein
the annular portion includes a flange portion protruding radially outward at a position away from the lock piece in the direction of the axis, and
the flange portion abuts an upper surface of the cap portion at the lock position.

10. The drive unit according to claim 9, wherein the flange portion is provided with an operation knob for rotating the lock piece about the axis.

11. The drive unit according to claim 1, wherein the operation jig and the cap portion include screw portions that are screwed to each other to attach the operation jig to the attachment and detachment opening.
